(19) United States
(12) Patent Application Publication
(10) Pub. No.: US 2014/0121011 A1
(43) Pub. Date: May 1, 2014

(54) METHOD AND SYSTEM FOR MOBILE SIMULATED REAL-TIME PLAYER VS. PLAYER GAMING

(71) Applicant: Nob Hill Studio Limited, Beijing (CN)

(72) Inventor: David Wanqian LIU, South San Francisco, CA (US)

(21) Appl. No.: 13/943,723

(22) Filed: Jul. 16, 2013

Related U.S. Application Data
(60) Provisional application No. 61/719,311, filed on Oct. 26, 2012.

(51) Int. Cl. A63F 13/12

(52) U.S. Cl. CPC A63F 13/12
USPC 463/31; 463/42

(57) ABSTRACT

A system for mobile simulated real-time player vs. player (PvP) gaming provides a user interface (UI) to a mobile device for simulated real-time player vs. player (PvP) gaming. A player selects an opponent and issues a challenge to the opponent's record on a song from the opponent's song list. The challenger then performs a simulated real-time challenge to the opponent's record on the song. If the challenger wins the challenge he/she is awarded bonus points. If the challenger loses, he can issue another challenge for the original song. To play a second round, the challenged player from the first round challenges the original challenger's record on the song. Winners get the right to a new challenge. Losers can purchase the right to a new challenge. Gameplay proceeds in a chain in which the players play alternating rounds.

### CROSS REFERENCE TO RELATED APPLICATIONS

This application claims benefit of U.S. provisional patent application Ser. No. 61/719,311, filed Oct. 26, 2012, the entirety of which is incorporated herein by this reference thereto.

### TECHNICAL FIELD

This disclosure pertains in general to mobile gaming and more specifically to a method and system for mobile simulated real-time player vs. player gaming.

### BACKGROUND

Multiplayer online games enjoy extraordinary popularity. The earliest of these games originated in the early- and mid-1970s and actually predate the Internet. The earliest multi-player computer games were played between two parties, each using a computer that was directly connected to the other by means of a serial cable. In the mid- and late 1970s, games appeared that could be played over ARPANET—a wide-area network developed by the Advanced Research Projects Agency.

In part due to rapidly proliferating ownership of personal computers and the increasing availability of modems, MUD (Multi-User Dungeon) was played by players who logged onto online bulletin boards hosted on proprietary networks such as COMPUSERVE and DELPHI. Many modern commercial games have millions of subscribers and can host many thousands of players at a single time.

As multi-user online gaming developed, games such as MUD began to incorporate opportunities for interactive conflict between or among single players as opposed to the “player vs. environment” and “realm vs. realm” conflict that had previously typified multi-user online gaming. The expression “player vs. player” was originally coined to describe combat between players that resulted in the loser being penalized in some way. Often, early PvP play involved the killing of players by other players. Being killed incurred a large penalty and killing another player caused the killer to incur serious character damage. PvP gameplay has gradually evolved to the point where PvP play may be the only type of play provided by a game.

A key feature of all multiplayer online gaming, is that play is done in real time. Exclusive real-time gameplay means that players must be online to play for the entire duration of their period of gameplay. Multiplayer online gaming is known for the inordinate amounts of time players devote to it. For some, a single session of gameplay may last many hours, and even days. However, because a fundamental feature of the games is that play takes place in real time, there seems no way of avoiding the commitment of large amounts of time to play. Additionally, multiplayer online games are ordinarily played by way of conventional computers. Thus, the player is tied to his or her computer during gameplay.

### SUMMARY

A system for mobile simulated real-time player vs. player (PvP) gaming provides a user interface (UI) to a mobile device for simulated real-time player vs. player (PvP) gaming. A player selects an opponent and issues a challenge to the opponent's record on a song from the opponent's song list. The challenger then performs a simulated real-time challenge to the opponent's record on the song. If the challenger wins the challenge he/she is awarded bonus points. If the challenger loses, he can issue another challenge for the original song. To play a second round, the challenged player from the first round challenges the original challenger's record on the song. Winners get the right to a new challenge. Losers can purchase the right to a new challenge. Gameplay proceeds in a chain in which the players play alternating rounds.

### BRIEF DESCRIPTION OF THE DRAWINGS

FIG. 1 provides a diagram of a machine in the exemplary form of a computer system within which a set of instructions, for causing the machine to perform any one of the methodologies discussed herein below, may be executed;

FIG. 2 provides a diagram of a client-server architecture across which a mobile gaming device for asynchronous multi-player gaming may be implemented;

FIG. 3 provides a schematic block diagram of a mobile gaming device;

FIG. 4 provides a sequence diagram of a simulated PvP chain structure;

FIG. 5 provides a block diagram of a process for management of a player's records for a song from the player's song list;

FIG. 6 provides a block diagram of a screen structure for a UI to a device for simulated real-time PvP gameplay;

FIG. 7 provides a screenshot of a report of the status of a player's song list;

FIG. 8 provides a detailed view of one of the records from the report of FIG. 7

FIG. 9 provides a detailed view of an exemplary message sent from one player to the other;

FIG. 10 provides a screenshot of an animation displayed as a challenge is loading;

FIG. 11 provides a screen shot of an animation showing the progress of a round;

FIG. 12 provides a screen shot report the final results of a round; and

FIG. 13 provides a screen shot of an interface for messaging between players.

### DETAILED DESCRIPTION

A system for mobile simulated real-time player vs. player (PvP) gaming provides a user interface (UI) to a mobile device for simulated real-time player vs. player (PvP) gaming. A player selects an opponent and issues a challenge to the opponent's record on a song from the opponent's song list. The challenger then performs a simulated real-time challenge to the opponent's record on the song. If the challenger wins the challenge he/she is awarded bonus points. If the challenger loses, he can issue another challenge for the original song. To play a second round, the challenged player from the first round challenges the original challenger's record on the song. Winners get the right to a new challenge. Losers can purchase the right to a new challenge. Gameplay proceeds in a chain in which the players play alternating rounds.

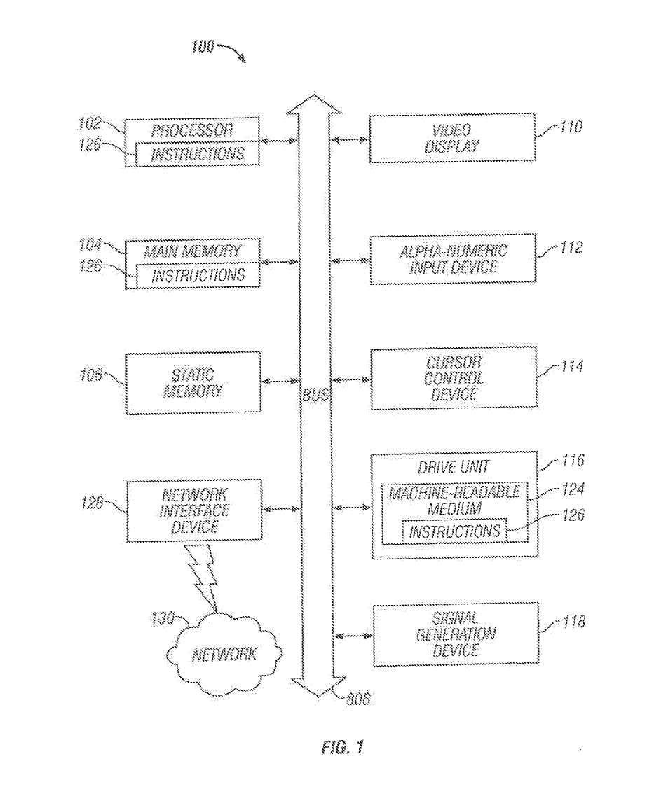

Referring now to FIG. 1, shown is a diagrammatic representation of a machine in the exemplary form of a computer system 100 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a display unit 110, for example, a liquid crystal display (LCD) or a cathode ray tube (CRT). The computer system 100 also includes an alphanumeric input device 112, for example, a keyboard; a cursor control device 114, for example, a mouse; a disk drive unit 116, a signal generation device 118, for example, a speaker, and a network interface device 128.

The disk drive unit 116 includes a machine-readable medium 124 on which is stored a set of executable instructions, i.e. software, 126 embodying any one, or all, of the methodologies described herein below. The software 126 is also shown to reside, completely or at least partially, within the main memory 104 and/or within the processor 102. The software 126 may further be transmitted or received over a network 130 by means of a network interface device 128.

In contrast to the system 100 discussed above, a different embodiment uses logic circuitry instead of computer-executed instructions to implement processing offers. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information. Additionally, a “machine-readable medium” may be understood to mean a “non-transitory” machine-readable medium.

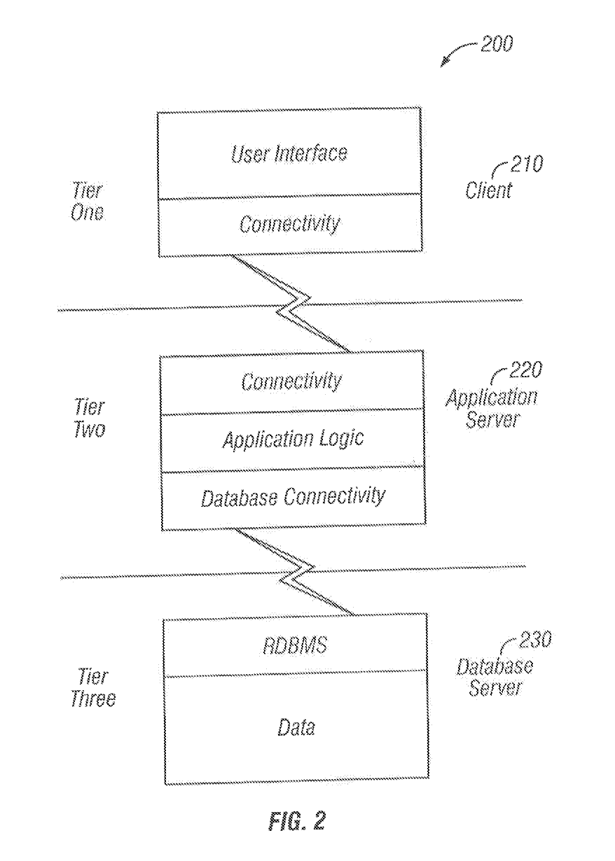

Referring now to FIG. 2, shown is a block diagram of a client-server architecture 200 over which at least one embodiment is implemented. In overview, the client-server architecture separates the various processes of an application into separate tiers, or layers. In an embodiment, each tier is housed separately from the other tiers on a separate device. In other embodiments, the tiers may be distributed across computing devices in other ways. In additional embodiments, the tiers may all be housed on a single computing device. As shown in FIG. 2, a client-server architecture may include a client 210, an Application server 212, and a database server. 214. As shown in FIG. 2, the client 210 may house the presentation layer, or user interface. In an embodiment, the user interface may be made up of a number of pages that one can access with a browser-type application. By interacting with the presentation layer or user interface, the user requests data from the database by entering input via various user interface elements. Additionally, the user, via the user interface is able to input data upon which the application layer may act, and which may also be saved to the database 214. Also, by means of the user interface, the user views data returned by the system in response to the user request.

The application server may house the application logic, such as game rules and functional modules that actually process data. Thus, the application layer provides most of the functionality specific to the present system and method. The application layer, however, does not store persistent data. In an embodiment, the presentation layer and the application server may both reside on a single device.

Finally, the database server 214 may house a database management system and a database for processing and storing persistent data. In addition to the foregoing, the various tiers or layers also incorporate connectivity elements for communicating with the adjacent tiers or layers.

In an embodiment, the client 210 may be a handheld wireless device such as a smartphone, upon which at least the presentation layer is implemented. In the present embodiment, the wireless device may communicate wirelessly with the Application layer 212. In an embodiment, both the presentation and the application layers reside on the wireless device, wherein the wireless device communicates via a wireless connection to a network containing the database layer 214. While a wireless handheld client potentially offers players great convenience and flexibility, allowing them to immediately enter plays and to receive results of their plays, in additional embodiments, a client may be a free-standing terminal, either wireless or wired. Additionally, in other embodiments, the client 210 may be a handheld computer, a laptop computer, or even a desktop computer upon which at least the presentation layer has been implemented.

In an embodiment, the database that orchestrates behind the scenes stores the data which drives gameplay.

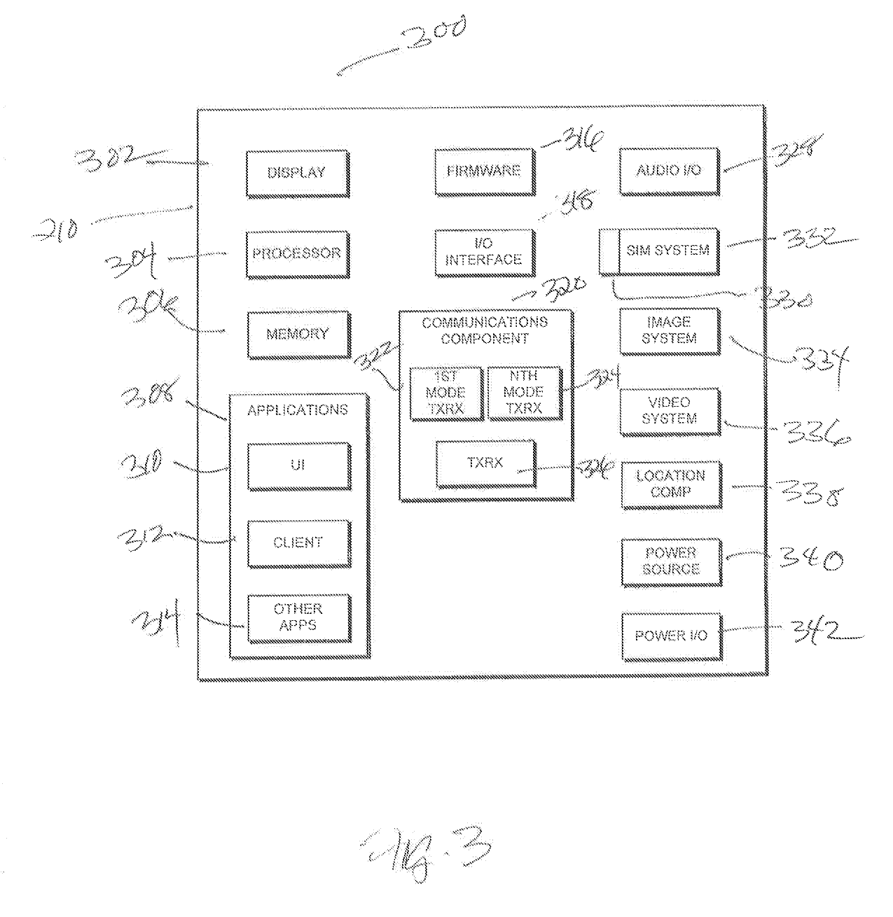

Referring to FIG. 3, provided is a schematic block diagram of a wireless client 210, as originally shown in FIG. 2. In embodiments, the wireless client 210 may be, for example, a smartphone or a dedicated mobile gaming device.

Although connections are not shown between all of the components illustrated in FIG. 3, the components can interact with each other to carry out device functions. In some embodiments, for example, the components are arranged so as to communicate via one or more busses (not shown). It should be understood that FIG. 3 and the following description are intended to provide a general understanding of a suitable environment in which the various aspects of some embodiments of the present disclosure may be implemented.

In at least one embodiment, the wireless client 210 includes a display 302 for displaying multimedia such as, for example, virtual objects, virtual object trajectories, application graphical user interfaces (GUIs), text, images, video, telephony functions such as Caller ID data, setup functions, menus, music, metadata, messages, wallpaper, graphics, Internet content, device status, preferences settings, map and location data and so on. In at least one embodiment, the wireless client 210 may also include a processor 304 for controlling, processing data, and/or executing computer-executable instructions of one or more applications including one or more asynchronous multi-user mobile gaming applications such as, for example, a real-time simulated PvP game.

In at least one embodiment, the wireless client 210 may also include a memory 306 for storing data and/or one or more applications 308, such as the real-time simulated PvP game application. In some embodiments, the memory 306 may store information associated with determining location of the wireless client 210.

In at least one embodiment, the application(s) 308 may include a user interface (UI) application 310. In at least one embodiment, the UI application 310 may interface with a client application or operating system (OS) 312 to, for example, facilitate user interaction with device functionality and data. In some embodiments, the OS 112 may be, for example the APPLE IPHONE OS (APPLE CORPORATION, Cupertino, Calif.), or Google ANDROID OS (GOOGLE, Inc., Mountain View, Calif.). These operating systems are merely exemplary of the operating systems that may be used herein.

In at least one embodiment, the UI application 310 may aid the user in entering message content, viewing received messages, answering/initiating calls, entering/deleting data, entering and setting user IDs and passwords, configuring settings, manipulating address book content and/or settings, interacting with other applications 314, and so on and may aid the user in inputting selections and maneuvers associated with one or more games as herein described.

In at least one embodiment, the other applications 314 may include, for example, add-ons, plug-ins, location applications, e-mail applications, music applications, video applications, camera applications, power conservation applications, game applications, productivity applications, entertainment applications, enterprise applications, customer information management applications, accounting applications, authentication applications, applications, proprietary business applications, combinations thereof, and the like. In at least one embodiment, the applications 308 may be stored in the memory 306 and/or in a firmware 316, and may be executed by the processor 304. The firmware 316 may also store code for execution during client 210 power up, for example.

In at least one embodiment, the wireless client 210 may also include one or more input/output (I/O) interfaces 318 for input/output of data, such as, for example, user IDs, passwords, and application initiation (start-up) requests. In some embodiments, the I/O interface 318 may be a hardwire connection, such as, for example, a USB, mini-USB, audio jack, PS2, IEEE 1394, serial, parallel, Ethernet (RJ48) port, RJ11 port, or the like. In some embodiments, the I/O interface 318 accepts other I/O devices such as, for example, keyboards, keypads, mice, interface tethers, stylus pens, printers, thumb drives, touch screens, multi-touch screens, touch pads, trackballs, joysticks, microphones, remote control devices, monitors, displays, liquid crystal displays (LCDs), combinations thereof, and the like. It should be appreciated that the I/O interface 318 may be used for communications between the wireless client 210 and one or more network or local devices, instead of, or in addition to, a communications component 320.

In at least one embodiment, the communications component 320 may interface with the processor 304 to facilitate wired and/or wireless communications with external systems. Example external systems include, but are not limited to, peer-to-peer networks, intranets, network databases, network storage systems, cellular networks, location systems, Voice over Internet Protocol (VoIP) networks, local area networks (LANs), wide area networks (WANs), metropolitan area networks (MANs), personal area networks (PANs), and other networks.

In at least one embodiment, the external systems are implemented using WIFI, WIMAX, combinations and/or improvements thereof, and the like. In some embodiments, the communications component 320 may include a multi-mode communications subsystem for providing cellular communications via different cellular technologies. In some embodiments, for example, a first cellular transceiver 322 operates in one mode, such as, Global System for Mobile communications (GSM), and an Nth cellular transceiver 324 operates in a different mode, such as Universal Mobile Telecommunications System (UMTS), while only two cellular transceivers 322, 324 are illustrated, the wireless client 210 may include more than two transceivers.

In at least one embodiment, the communications component 320 may also include a transceiver 326 for use by other communications technologies such as, for example, WIFI, WIMAX, BLUETOOTH, infrared, infrared data association (IRDA), near field communications (NFC), RF, and the like. In some embodiments, the communications component 320 may also facilitate reception from terrestrial radio networks, digital satellite radio networks, Internet-based radio services networks, combinations thereof, and the like. In at least one embodiment, the communications component 320 may process data from a network such as, for example, the Internet, an intranet, a home broadband network, a WIFI hotspot, and the like, via an ISP, DSL provider, or broadband provider.

In at least one embodiment, audio capabilities for the wireless client 210 may be provided by an audio I/O component 328 including a speaker to output audio signals and a microphone to receive audio signals.

In at least one embodiment, the wireless client 210 may also include a slot interface 330 for accommodating a subscriber identity system 332 such as, for example, a subscriber identity module (SIM) card, a universal SIM (USIM) card, or a universal integrated circuit card (UICC). Alternatively, the subscriber identity system 332 may be manufactured into the wireless client 210, thus rendering the slot interface 330 unnecessary. In at least one embodiment, the subscriber identity system 332 may be programmed by a manufacturer, a retailer, a user, a computer, a network operator, or the like.

The wireless client 210 may also include an image capture and processing system 334 (image system). Photos can be obtained via an associated image capture subsystem of the image system 334, for example, a camera. The wireless device 210 may also include a video system 336 for capturing, processing, recording, modifying, and/or transmitting video content.

In at least one embodiment, the wireless client 210 may also include a location component 338 for use in determining geographic location of the wireless client 210. The location component 138 may include, for example, a GPS receiver.

In at least one embodiment, the wireless client 210 may also include a power source 340, such as batteries and/or other power subsystem (AC or DC). The power source 340 may interface with an external power system or charging equipment via a power I/O component 342.

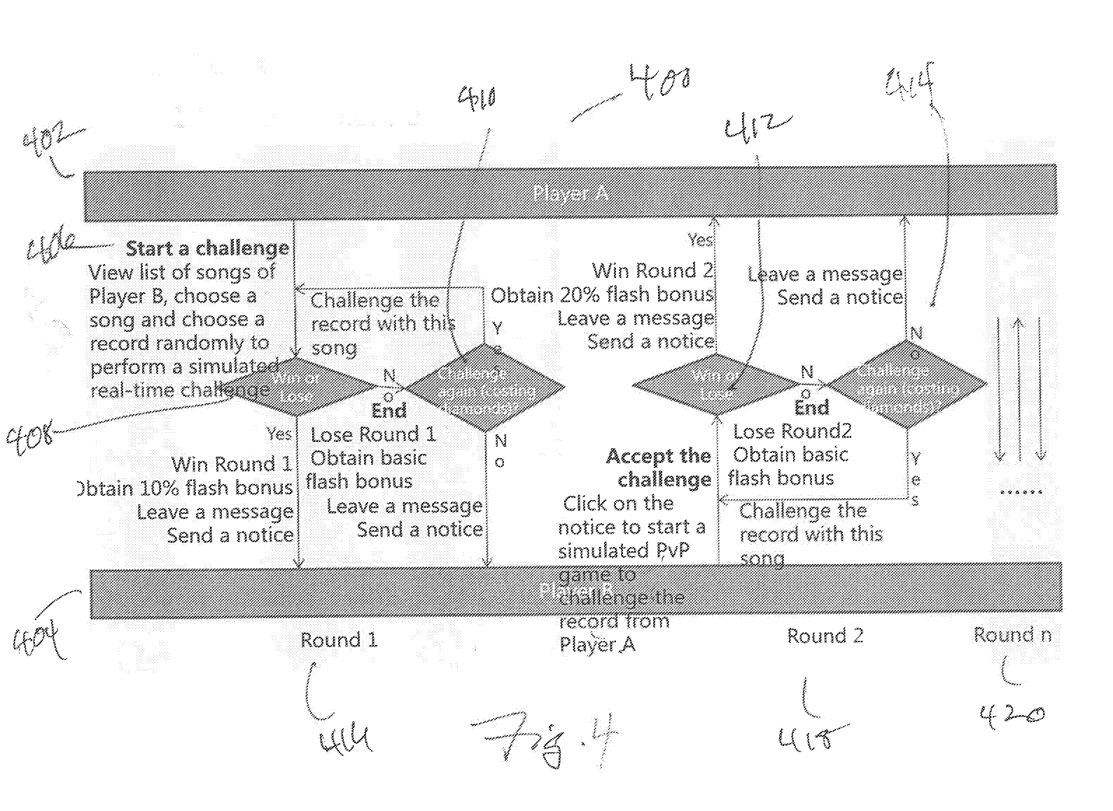

Referring now to FIG. 4, provided is a diagram illustrating the chain structure 400 of successive rounds of play between two players, for example, Player A 402 and Player B 404, in a game that provides real-time simulated PvP gameplay. In at least one embodiment, a rival (Player A 402) initiates a challenge involving a song selected from a song list associated to Player B 404.

Start A Challenge 406

In at least one embodiment, Player A 402 may view a song list associated to Player B 404. Player A may than choose a record from the list to perform a simulated real-time challenge. The choice may be random, or may be driven by Player A's preference for one song over another of the songs listed on Player B's song list. Player A's challenge is to the record held by Player B for a challenge related to the song selected by Player A 402. Of course, the outcome of the challenge is that Player A 402 either wins or loses 408 round 1.

If Player A 402 wins round 1 (416), he or she is awarded a point bonus and also has the option of leaving a message or sending a notice to Player B 404, issuing a new challenge to Player B.

If Player A 402 loses his/her initial challenge, as shown in decision block 410, Player A 402 may again leave a message or send a notice to Player B 404. Additionally, Player A 402 may use points to purchase the right to re-challenge Player B 404. The outcome of the challenge, of course will be that Player A either wins or loses the challenge and gameplay proceeds as described above.

Referring now to Round 2 418 in FIG. 4, Player B 404 may accept the invitation from Player A 402 to challenge Player A's 402 record from Round 1 416. As shown in decision block 412, the outcome of Player B's 404 challenge to Player A is, of course, that Player B 404 either wins or loses the challenge.

If Player B 404 wins the round 412, Player B 404 may be awarded a point bonus and may leave a message or send a notice to Player A 402 issuing a new challenge to Player A 402. The challenge is for the same song.

If Player B 404 loses Round 2 418, Player B may use points to purchase the right to challenge Player A's 402 record again. As shown in FIG. 4, play proceeds in a chain of rounds 420 with the role of challenger alternating between players in successive rounds.

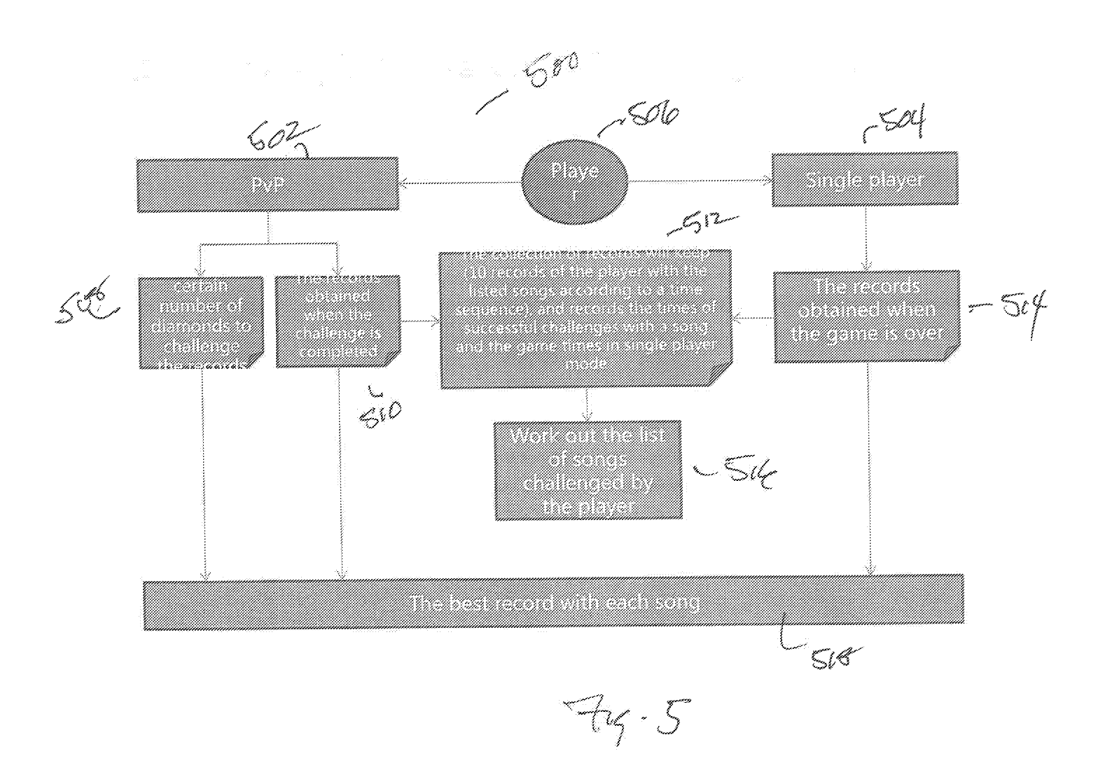

Turning now to FIG. 5, provided is a flow diagram of a process 500 for managing a user's records for a particular song in the player's song list. As shown in FIG. 5, in at least one embodiment, there are provided multiple play modes 506: single player 504 and PvP 502.

In PvP mode 502, in order to challenge a record 508, a rival must pay for the right to initiate a challenge using points or tokens. Additionally, the records are created and listed 510 when the challenge is completed.

In single-player mode 504, records are created and listed 514 when the game is over.

In either single-player mode or PvP mode, a predetermined number of records for the player are maintained for each song 512. Additionally, for PvP mode 502, the times of challenges are recorded. For single-player mode, the times of games are recorded.

The system then generates a list of the songs challenged by the player 516 and also determines the highest score associated with each song.

### Rules for Formulation of a List of Songs Challenged by Player

It will be appreciated that a policy for management of a player's song list embodies one or more rules. In at least one embodiment, a policy for managing a player's song list may include at least one of the following rules:
The records in the song collection expire after 30 days, meaning that, in 30 days, the records are removed from the song collection. Expiration period, however, is a variable design parameter. 30 days is merely an example;
The latest 10 results with each song and the game times within 30 days are recorded. This again is a variable design parameter;
If players play the game with new songs updated weekly for more than 5 times, such new song is listed on the top of the list, which is known as PRIORITY OF NEW SONGS. The number of games involving a particular song to be placed at the top of the list is a variable design parameter;
The songs in the list are rated according to a plurality of grades, for example: A[1-20], B[21-50], and C[above 50]; and are listed according to the rule: C>B>A, which is also known as PRIORITY OF QUANTITY;
For songs in the list and in each grade, they are arranged on the basis of the last game with such song, which means that the song used in the latest game is listed on the top. This is also known as TIME PRIORITY;
The rules have different priority levels, such as priority of new song>priority of quantity>time priority;
Each player may have a maximum number of songs in his/her challenge songs; as an example, the maximum number may be 15, but the number is a variable design parameter; and
Songs without records do not appear in the list of challenge songs.

### Rules for Simulated Real-Time PvP Gameplay

It will be appreciated that gameplay, either for the single-player or the PvP mode, proceeds according to predetermined rules. In at least one embodiment, the rules for the PvP mode may include at least one of the following rules:
Game results are recorded every 5 seconds (or another predetermined time interval);
When a player challenges another player, the challenging player shall choose a song from the song list of the challenged player and a record of such challenged player with such song to perform a simulated real-time challenge with the chosen song;
When a player accepts the challenge, the challenging player clicks on a ‘challenge’ button and enters a simulated real-time challenge against a record won by the challenged player with the song;
When the song is played, the comparison is refreshed every 5 seconds on the basis of the scores (or another predetermined time interval). The player with the higher score is listed at a higher position and highlighted;
The scores decide whether a player wins or loses the game; and
The player can restart the game by consuming a predetermined number of diamonds, which may change from one round of the game to another.

### Screen Structure

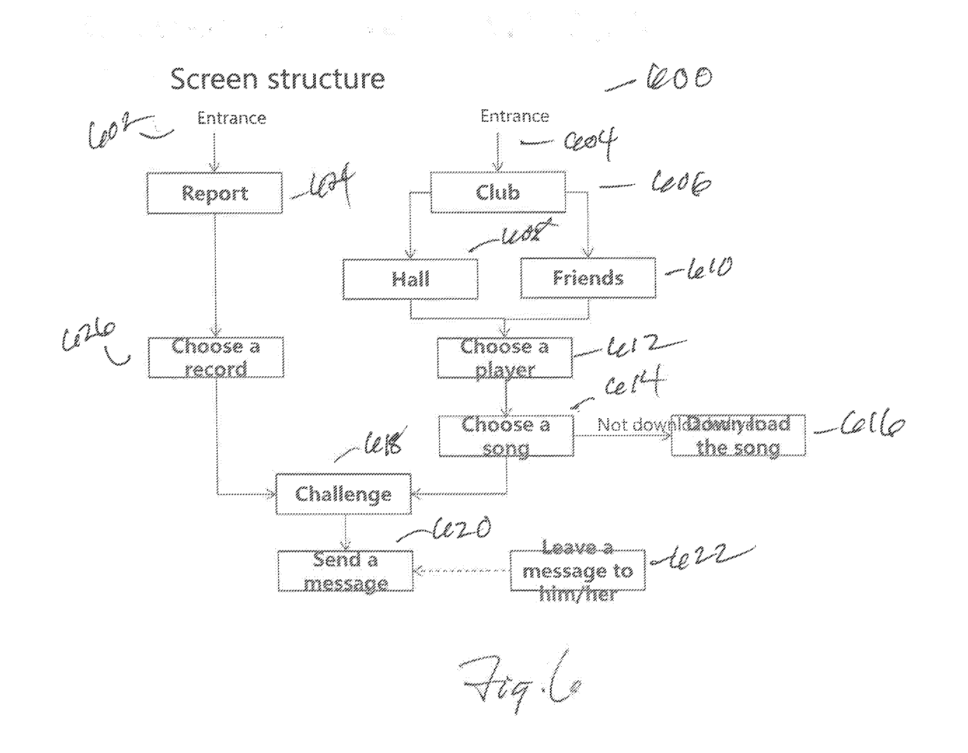

FIG. 6 provides a schematic diagram of a screen structure 600. As shown in FIG. 6, a user interface for conducting gameplay as described herein may be composed of a number of linked screens or pages. As shown in FIG. 6, an embodiment provides multiple points of entry 602, 604 to the screen structure. For example, a first point of entry 602 may give a player direct access to a report 624 listing a number of records. The player may choose a record 626 and perform a challenge 618. The player then sends a message to the challenged player 620 and, in turn, the challenged player may leave a message for the original player 622.

As shown in FIG. 6, a second point of entry 604 may allow the player to drill down a number of levels to a list of players. To reach the list of players, the player may first access a ‘club’ screen 606, followed by either of a ‘hall’ screen 608 and a ‘friends’ screen 610. By either route, the player is navigated to a screen from which he/she chooses an opponent 612 and then a song 614. If the player has not downloaded the song, he or she may be given an option to download the song 616. After choosing a song, gameplay proceeds to performance of the challenge 618 and message exchange 620, 622.

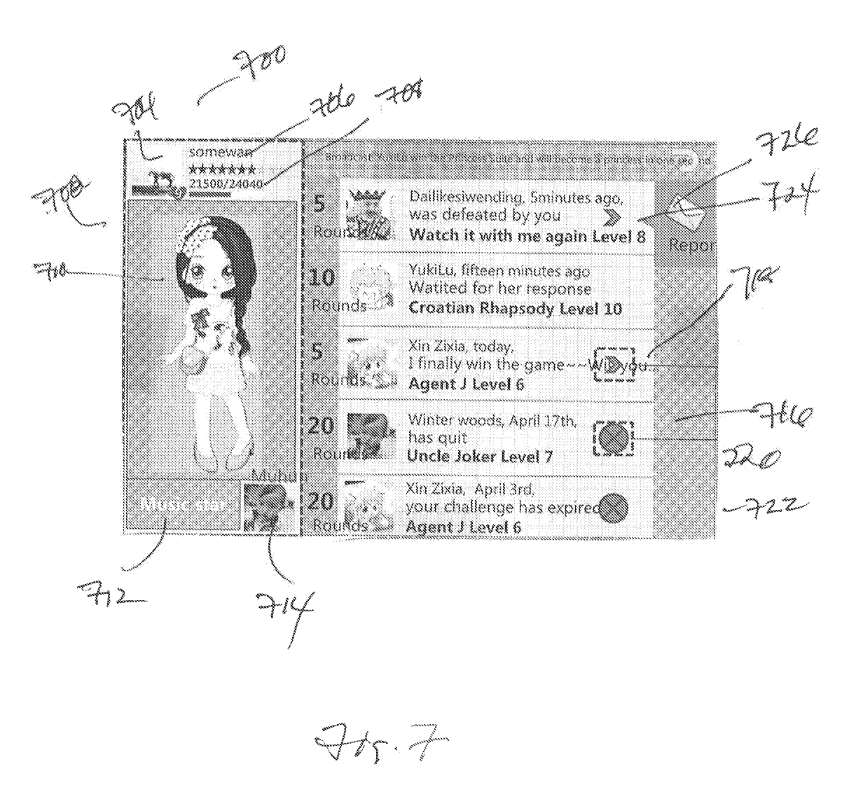

Turning now to FIG. 7, shown is a screenshot of a report 700 listing a player's records. In an embodiment, a first section of the report 702 may contain at least one of the following elements:
an avatar 704;
a screen name 706;
experience and charm values of the player 708;
a character image 710;
a title awarded the player 712; and
the avatar of the player's partner 704. The player title is integrated with a character image of the partner. If the partner does not have an avatar, a default image is displayed and a level of intimacy is indicated on the avatar.

A second section of the report 716 displays a number of entries—the player's records. One or more of the records 720, 722 may be expired and are marked with a deletion icon. Activation of the deletion icon removes the expired entries from the list.

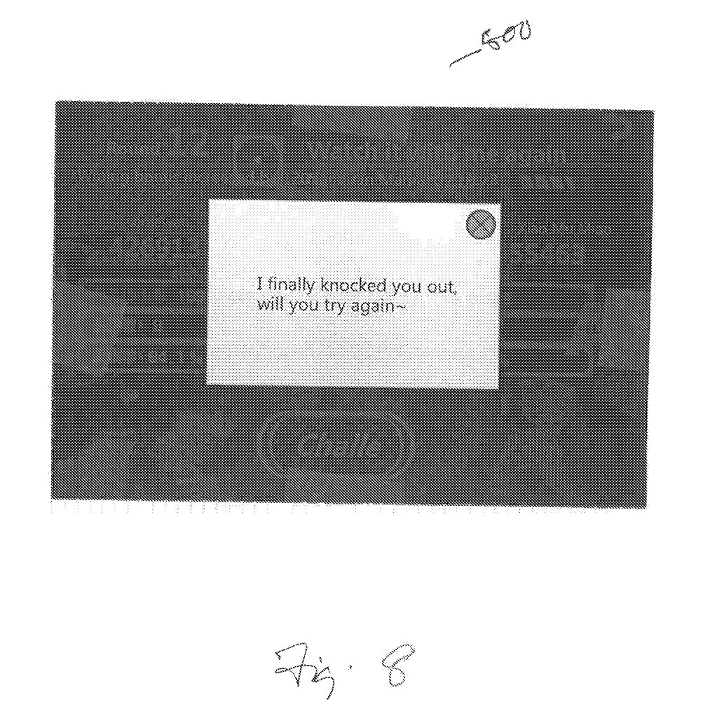

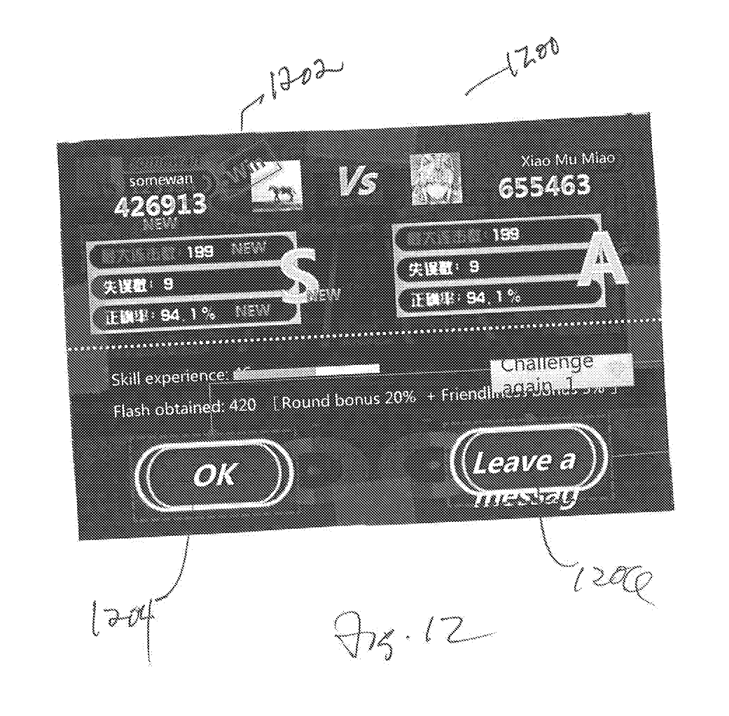

Operable entries 718 may be so indicated, for example, by being marked with arrows, meaning that the entry is editable. Clicking on the arrow may grant access to more detailed reports as shown in FIGS. 8-13.

In an embodiment, each round may have a valid period of, for example, 15 days. If a challenge is not made in 15 days, the notice entry of the challenging player may display “Challenge has expired” 722 and the notice entry of a player waiting for challenge will display “xxx has quit” 720. Both players may delete their notice entries or they will be removed automatically after elapse of a predetermined time period, for example, 15 days.

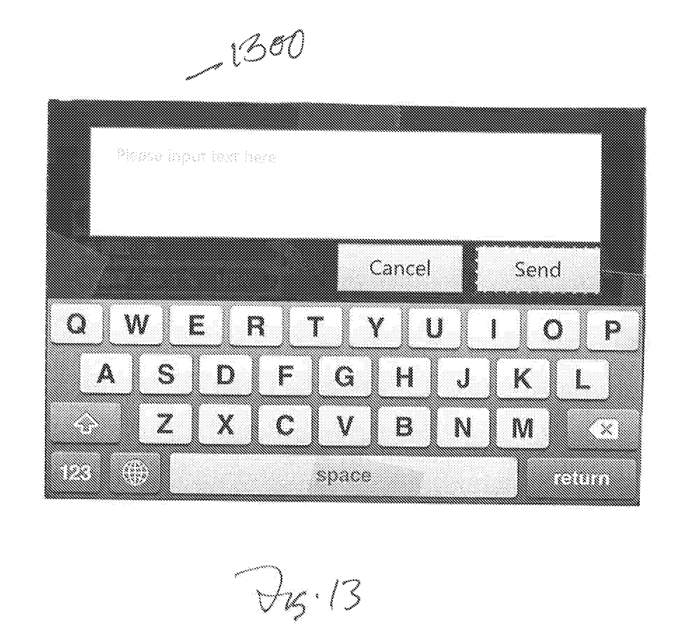

As previously described, the application provides the players with the ability to message each other in order to issue challenges and to accept challenges. FIG. 8 is a screen shot of a message 800 issuing a challenge. Additionally, FIG. 13 provides a screenshot of a messaging UI 1300 whereby opponents can exchange messages with each other in order to exchange challenges and acceptances or challenges.

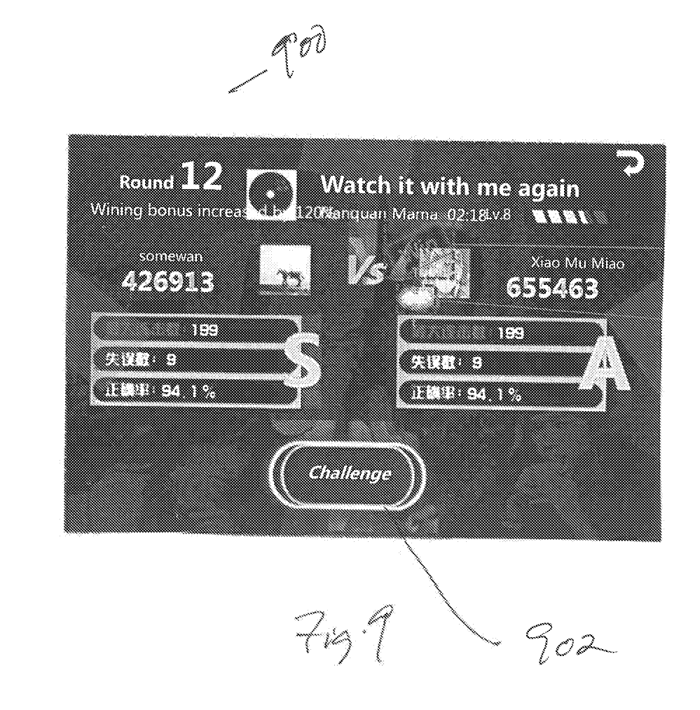

As shown in FIG. 7, a record 724 indicates that a report 726 is available for the record. By clicking the report icon 726, the player is navigated to a more detailed report of the challenge 900, as shown in FIG. 9. In an embodiment, the report may list the final score, the avatar and screen name and the final score for each party. Additionally, a ‘challenge’ button 902 is prominently displayed, activation of which may navigate the player to the messaging UI 1300 in order to compose a challenge to the selected opponent. The ‘win’ or ‘lose’ mark is only stamped on the avatar of the rival. When a player views the detailed report, if there is a message from the rival, the message may be opened as above, and may be closed when the player clicks on any part of the screen.

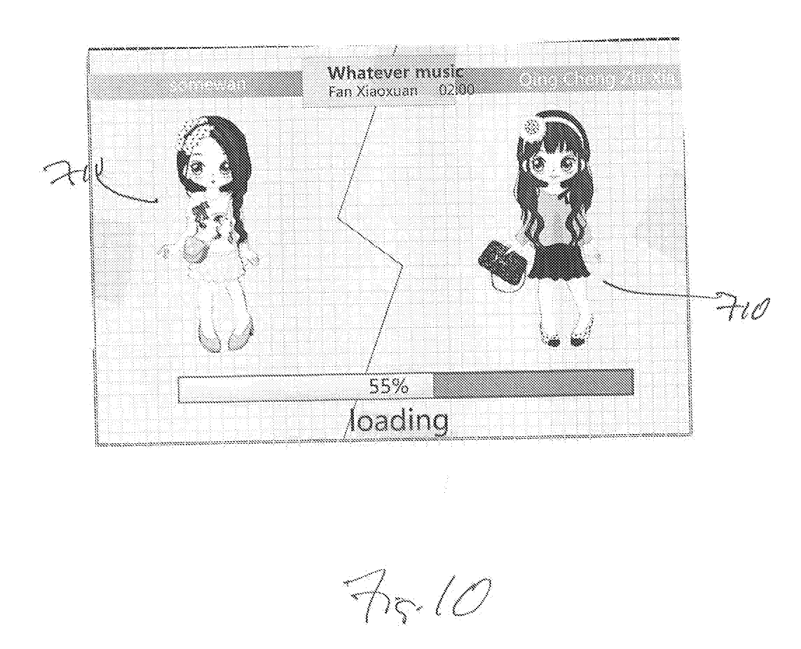

After a challenge has been issued and accepted, in at least one embodiment, a screen 1000 such as that shown in FIG. 10 may be displayed. As the song and the challenge are loading, the character images 710 of the players along with their screen names 706 may be displayed, for example, alongside each other. In terms of the animation sequence, the character image of the rival is displayed first, and if it is wearing a PK suit, brief music is played; then, the character image of the player is displayed, similarly, if the character image is wearing a PK suit, a brief song is played. Finally, there may be a brief PK animation, after which the system begins to load songs.

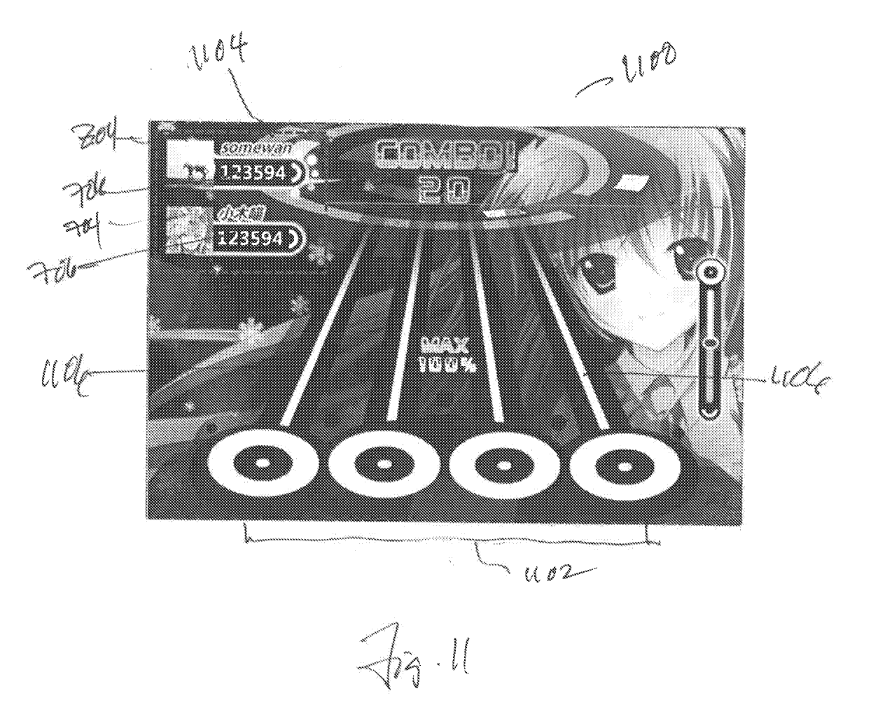

Referring now to FIG. 11, shown is a screen 1100 for simulated real-time PvP gameplay. As previously explained, the challenger selects another player to challenge and selects a song from a song list associated to the other player. The challenger then issues a challenge to the other player.

After the other player accepts the challenge, a display such as shown in FIG. 11 is presented to the challenger. As previously explained, the songs on the challenged player's song list are those songs that the challenged player himself has completed a challenge on. In at least one embodiment, the challenge may be completion of at least one round of a game known as BEATMASTER. In other embodiments, the challenge may be based on other mobile games involving songs and song lists. In still further embodiments, the challenge may be based on other computer- or videogames that do not involve songs and song lists.

The BEATMASTER game is a mobile game involving songs and song lists wherein a player selects a song and completes a challenge on the song. In BEATMASTER, the player is challenged to keep beat with the chosen song by tapping with his/her fingertips on a prescribed section of the screen 1100. As shown in FIG. 11, a plurality of circles 1102 is disposed along the bottom of the screen. It is within these circles that the player is required to tap with his/her fingers to keep beat with the song being played. Attention is drawn to a circular entity 1104 disposed at the top of the screen that resembles a disk or a circular track. Projecting from the circular entity in the direction of the circles is a plurality of tracks, each one of which makes contact with a different one of the circles. During gameplay, as the song plays and the player keeps beat with the song by tapping with his/her fingertips within the circles, discs emerge from the circular entity to travel down the tracks, for example in a gliding or sliding fashion. In an embodiment, the discs are discharged from the circular entity as single discs or in groups of 2 or more discs. In an embodiment, the tempo of the song determines the speed at which the discs emerge from the circular entity; for example, the discs are produced more slowly in a song with a relatively slower tempo. Additionally, in an embodiment, the tempo of the song also determines the speed at which the discs travel along the tracks; for example, for a faster song, the discs travel along the tracks at a relatively higher speed.

The challenge posed by the game is that the player, while keeping beat with the song, must intercept a disc or a group of discs traveling along a track toward the corresponding circle by tapping within the circle. Additionally, the player must perform this task while keeping beat with the music. For every disc that the player successfully intercepts while keeping beat with the song, the player is awarded a predetermined number of points. In at least one embodiment, the player may be penalized for failing to intercept discs. In an embodiment, a player may be penalized for failing to keep beat with the song's rhythm.

Additional challenge to the player is provided by the rhythm of the song. Keeping beat with a song having a relatively more complex rhythm is more difficult than keeping beat with a simpler rhythm. In at least one embodiment, gameplay is organized by level of difficulty. It will be appreciated that level of difficulty may be determined, at least in part by song tempo and rhythm complexity. As shown in FIG. 11, four circles are provided for the player to use to tap out the song's rhythm. However, the number of circles the player manages may vary according to the level of gameplay. In an embodiment, for example, a relatively easy level involves three circles. Additionally, the player may keep beat with the song by using the fingers of one hand or by alternating the fingers of both hands.

In at least one embodiment, the game may be a single-player game, without opponents, in which the single player attempts to surpass his/her previous records.

In at least one further embodiment, the game may provide both a single-player option and a simulated real-time PvP option.

Referring again to FIG. 11, the screen 1100 shows simulated real-time PvP gameplay in progress. As previously described herein above, during gameplay, a player's results are recorded at regular intervals, 5 seconds, for example. It will be appreciated that the time interval for recording player results is a variable design parameter. This is the case both for single-player games and for simulated PvP games. Thus, the system maintains, for each player, for each song, a complete record of every game played, up to a maximum number of games. It will be appreciated that the maximum number of games is a variable design parameter.

During a simulated PvP game, the screen 1100 displays the avatars of both the challenger and the challenged players. As the game proceeds, the challenger's score is monitored and stored at the preconfigured intervals, for example, every 5 seconds. At the same time, the challenger's score is displayed on the screen, and is updated at the same intervals at which the score is saved. In an embodiment, as shown in FIG. 11, a UI element in close proximity to the challenger's avatar display's the challenger's score.

Because the challenged player's scores for the song have previously been saved at the same intervals as the challenger's scores are saved and displayed, the challenged player's results can be displayed at the same time as the challenger's results are displayed. In terms of the scores of the two players, the scores are compared at regular intervals of, for example, 5 seconds. As the scores are compared, the user interface is reordered to reflect who has the better score, the challenger or the challenged player. For example, the name and avatar of the player having the higher score may be displayed first, and/or may be highlighted or otherwise graphically emphasized in some way.

It is to be appreciated that, because gameplay does not proceed between two actual players, but between a player (the challenger) and a saved game previously played by the challenged player, the gameplay is a simulation, or a virtualization, of a PvP game. Thus, the challenger does not play against an actual opponent, but against a virtualization of his/her chosen opponent.

At the conclusion of the challenge, a report 1200 is displayed, summarizing the result of the challenge. As in previous reports, the avatars and screen names of the players are displayed. The winning player is identified 1202. Additionally, the scores are reported, the skill level of the round and the number of bonus points awarded. Clicking an ‘OK’ button 1204 closes the report and a ‘leave a message’ button 1206 allows the player to message his or her opponent via the UI of FIG. 13.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A computer-implemented method for real-time simulation of player vs. player (PvP) gameplay comprising:
a computer receiving a challenge to a second player from a first player, the challenge being entered by the first player via a mobile device controlled by the first player and comprising a challenge to a record held by said second player for a game played via mobile device;
said computer relaying said challenge to a mobile device controlled by said second user;
responsive to receiving an acceptance of the challenge, the computer presenting a round of the game to the first user via a user interface to the mobile device controlled by the first user;
concurrent with the computer receiving game plays input by said first player via said mobile device controlled by said first player, said computer presenting to said first player via the user interface to the mobile device controlled by the first user a virtualization of the second player that simulates real-time PvP game play between the first player and the second player;
responsive to making a determination that the first player has beaten the second player's record, the computer issuing a selection of the first player as the winner of the round;
responsive to making a determination that the first player did not beat the second player's record, the computer issuing a selection of the second player as winner;
after selection of a winner, responsive to receipt of a challenge from one of the first player and the second player, the computer beginning a new round of the game.

2. The method of claim 1, wherein said computer receiving a challenge to a second player from a first player comprises:
said computer receiving a selection of the second player, the selection of the second player being entered by the first player via the mobile device controlled by the first user;
said computer displaying, to said first player, a song list associated to said second player via a user interface to said mobile device to controlled by the first player;
said computer receiving a selection of a song from the song list associated to the second user, the selection of the song being entered by the first player via the mobile device controlled by the first user;
said computer displaying, to said first player, a record of the second player on the selected song via a user interface to said mobile device controlled by the first player; and
said computer receiving a selection of a record of the second player on the selected song, the selection of the record being entered by the first player via the mobile device controlled by the first user.

3. The method of claim 2, wherein said computer relaying said challenge to a mobile device controlled by said second user comprises:
said computer relaying a selection of a song from a song list associated to the second user to said mobile device controlled by the second player; and
said computer relaying a selection of a record associated to the second player on the selected song;
wherein the selection of the song and the selection of the record are entered via the user interface to said mobile device controlled by the first user.

4. The method of claim 1, wherein the computer presenting a round of the game to the first user via a user interface to the mobile device controlled by the first user comprises:
via the user interface to the mobile device controlled by the first player, the computer:
playing a song selected by the first player from a song list associated to the second player;
displaying a plurality of user interface elements whereby the first player keeps beat with the song being played by rhythmically activating at least one of the plurality of user interface elements, and whereby the first player intercepts virtualized projectiles in time with the song's rhythm, wherein the first player accrues points according to the number of projectiles intercepted; and
the computer receiving data regarding the first user's gameplay and tallying the first user's score at periodic intervals; and
the computer displaying the first user's score as it is tallied at the periodic intervals.

5. The method of claim 1, wherein said computer presenting to said first player via the user interface to the mobile device controlled by the first user a virtualization of the second player that simulates real-time PvP gameplay between the first player and the second player comprises:
via the user interface to the mobile device controlled by the first player, the computer:
displaying avatars associated to the first user and the second user;
in close proximity to the avatar associated to the first user, displaying a score accrued by the first user and incremented by said computer at periodic time intervals;
in close proximity to the avatar associated to the second player, displaying a score accrued by the second user on a previous round of the game, as though the first play and the second player were real-time opponents; and
rearranging the user interface elements at periodic intervals according to the relative scores of the first player and the second player to indicate which player is ahead.

6. The method of claim 1, wherein the computer beginning a new round of the game comprises:
responsive to the loser entering a challenge, the computer charging the loser one or more tokens to issue the challenge and limiting the challenge to repeating the round just played; and
responsive to the winner entering a challenge, the computer issuing the challenge without charging the winner and accepting only a newly-selected challenge.

7. The method of claim 1, wherein gameplay is organized according to levels of difficulty, wherein level of difficulty is a function of one or more of:
tempo of a song being selected;
complexity of rhythm of a song being selected;
the speed at which gameplay proceeds; and
the complexity of tasks players are challenged with.

8. The method of claim 1, wherein said game provides an option for single-player gameplay.

9. The method of claim 1, further comprising:
said computer organizing a list of songs challenged by a player according to at least one of:
priority of new songs;
priority of song quantity; and
time priority; wherein
priority of new song>priority of quantity>time priority.

10. The method of claim 1, further comprising:
said computer displaying, for each player, an animated avatar on said user interfaces to said mobile devices.

11. A system for real-time simulation of player vs. player (PvP) gameplay comprising:
at least one computer; and
at least one mobile device communicatively coupled to said computer; and
computer-readable instructions for:
receiving a challenge to a second player from a first player, the challenge being entered by the first player via a mobile device controlled by the first player and comprising a challenge to a record held by said second player for a game played via mobile device;
relaying said challenge to a mobile device controlled by said second user;
responsive to receiving an acceptance of the challenge, presenting a round of the game to the first user via a user interface to the mobile device controlled by the first user;
concurrent with receiving game plays input by said first player via said mobile device controlled by said first player, presenting to said first player via the user interface to the mobile device controlled by the first user a virtualization of the second player that simulates real-time PvP game play between the first player and the second player;
responsive to making a determination that the first player has beaten the second player's record, issuing a selection of the first player as the winner of the round;
responsive to making a determination that the first player did not beat the second player's record, issuing a selection of the second player as winner;
after selection of a winner, responsive to receipt of a challenge from one of the first player and the second player, beginning a new round of the game.

12. The system of claim 11, wherein said computer-readable instructions for receiving a challenge to a second player from a first player comprise computer-readable instructions for:
receiving a selection of the second player, the selection of the second player being entered by the first player via the mobile device controlled by the first user;
displaying, to said first player, a song list associated to said second player via a user interface to said mobile device to controlled by the first player;
receiving a selection of a song from the song list associated to the second user, the selection of the song being entered by the first player via the mobile device controlled by the first user;
displaying, to said first player, a record of the second player on the selected song via a user interface to said mobile device controlled by the first player; and
receiving a selection of a record of the second player on the selected song, the selection of the record being entered by the first player via the mobile device controlled by the first user.

13. The system of claim 12, wherein said computer-readable instructions for relaying said challenge to a mobile device controlled by said second user comprise computer-readable instructions for:
relaying a selection of a song from a song list associated to the second user to said mobile device controlled by the second player; and
relaying a selection of a record associated to the second player on the selected song;
wherein the selection of the song and the selection of the record are entered via the user interface to said mobile device controlled by the first user.

14. The system of claim 11, wherein the computer-readable instructions for presenting a round of the game to the first user via a user interface to the mobile device controlled by the first user comprise computer-readable instructions for:
via the user interface to the mobile device controlled by the first player:
playing a song selected by the first player from a song list associated to the second player;
displaying a plurality of user interface elements whereby the first player keeps beat with the song being played by rhythmically activating at least one of the plurality of user interface elements, and whereby the first player intercepts virtualized projectiles in time with the song's rhythm, wherein the first player accrues points according to the number of projectiles intercepted; and
receiving data regarding the first user's gameplay and tallying the first user's score at periodic intervals; and
displaying the first user's score as it is tallied at the periodic intervals.

15. The system of claim 11, wherein said computer-readable instructions for presenting to said first player via the user interface to the mobile device controlled by the first user a virtualization of the second player that simulates real-time PvP gameplay between the first player and the second player comprise computer-readable instructions for:
via the user interface to the mobile device controlled by the first player:
displaying avatars associated to the first user and the second user;
in close proximity to the avatar associated to the first user, displaying a score accrued by the first user and incremented by said computer at periodic time intervals;
in close proximity to the avatar associated to the second player, displaying a score accrued by the second user on a previous round of the game, as though the first play and the second player were real-time opponents; and
rearranging the user interface elements at periodic intervals according to the relative scores of the first player and the second player to indicate which player is ahead.

16. The system of claim 11, wherein the computer-readable instructions for beginning a new round of the game comprise computer-readable instructions for:
responsive to the loser entering a challenge, charging the loser one or more tokens to issue the challenge and limiting the challenge to repeating the round just played; and
responsive to the winner entering a challenge, issuing the challenge without charging the winner and accepting only a newly-selected challenge.

17. The system of claim 11, wherein gameplay is organized according to levels of difficulty, wherein level of difficulty is a function of one or more of:
tempo of a song being selected;
complexity of rhythm of a song being selected;
the speed at which gameplay proceeds; and
the complexity of tasks players are challenged with.

18. The system of claim 11, further comprising computer-readable instructions for:
organizing a list of songs challenged by a player according to at least one of:
priority of new songs;
priority of song quantity; and
time priority; wherein
priority of new song>priority of quantity>time priority.

19. The system of claim 11, further comprising computer-readable instructions for:
displaying, for each player, an animated avatar on said user interfaces to said mobile devices.

20. A computer program product comprising a non-transitory, computer-readable medium having computer-readable instructions embodied thereon, which instruction when executed by a computing device perform steps of a method for real-time simulation of player vs. player (PvP) gameplay comprising:
receiving a challenge to a second player from a first player, the challenge being entered by the first player via a mobile device controlled by the first player and comprising a challenge to a record held by said second player for a game played via mobile device;
relaying said challenge to a mobile device controlled by said second user;
responsive to receiving an acceptance of the challenge, presenting a round of the game to the first user via a user interface to the mobile device controlled by the first user;
concurrent with receiving game plays input by said first player via said mobile device controlled by said first player, presenting to said first player via the user interface to the mobile device controlled by the first user a virtualization of the second player that simulates real-time PvP game play between the first player and the second player;
responsive to making a determination that the first player has beaten the second player's record, issuing a selection of the first player as the winner of the round;
responsive to making a determination that the first player did not beat the second player's record, issuing a selection of the second player as winner;
after selection of a winner, responsive to receipt of a challenge from one of the first player and the second player, beginning a new round of the game.
